(19) United States
(12) Patent Application Publication
(10) Pub. No.: US 2009/0025514 A1
(43) Pub. Date: Jan. 29, 2009

(54) Wheel stud installing and removing system and method

(75) Inventors: Jose O. Barrios, Owatonna, MN (US); John Nicholas Lindberg, Mankato, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/878,869

(22) Filed: Jul. 27, 2007

(51) Int. Cl. B25B 13/50

(52) U.S. Cl. 81/53.2

(57) ABSTRACT

A wheel stud installing and removing system includes a C-frame; a forcing screw configured to communicate with the C-frame to move laterally through the C-frame; a swivel mounted on an end on the forcing screw; an adapter receiver mounted on an opposite end of the C-frame from the forcing screw, and configured to receive at least one of either a stud installing adapter and a stud removing adapter. A method of moving a stud includes: inserting one of either an installing adapter or a removing adapter into an adapter receiver on a C-frame; aligning a longitudinal axis of the adapter with a longitudinal axis of the stud; aligning the longitudinal axis of the stud with a longitudinal axis of a forcing screw; and turning the forcing screw.

### FIELD OF THE INVENTION

The present invention relates generally to installing and removing shafts within a hole. More particularly, the present invention relates to installing and removing wheel studs on a hub assembly.

### BACKGROUND OF THE INVENTION

Wheeled vehicles have wheel assemblies, which usually consist of a rubber tire connected to a metal wheel rim. The metal wheel rim, which is often steel or aluminum, is equipped with an array of holes. The wheel assembly is fitted to the vehicle by aligning the holes in the wheel rim with studs mounted in a hub assembly. Once the holes in the wheel rim have been aligned with the studs, the wheel assembly is placed onto the hub assembly causing the studs to extend through the holes in the wheel rim. The wheel is then secured onto the hub assembly with lug nuts tightened onto the studs.

From time to time, and for various reasons, the studs may need to be replaced. For example, a stud may break. In other instances, the threads on the stud, to which the lug nuts attach, may become stripped or otherwise damaged.

Often, the studs are bolts that extend through a flat disc portion of the hub assembly. Often, the studs are press fit into the holes in the flat disc portion of the hub assembly. On one side of the flat portion of the hub assembly, the studs have heads. The heads prevent the studs from moving completely through the hub and permit the wheel assembly to be tightly attached to the hub assembly when the nuts are torqued onto the studs.

Because the studs are often press fit into their respective holes in the hub assembly, installing and removing studs to and from the hub assembly may be difficult to do by hand.

Some tools have been developed in order to facilitate installing and removing studs from the hub assembly. Some known systems use tools that grip the stud by the threads and apply force through the studs via the threads to install or remove the stud. While these systems may work well in some applications, other applications may lend themselves to be well served by tool systems that remove or install the stud by applying force to the stud at places other than the threads.

An issue to consider is that the studs are installed on a flat disc portion of the hub assembly. The flat disc portion of the hub assembly may be subject to being warped or otherwise deformed if a tool installing or removing a stud applies an undesirable amount of force to the flat disc portion of the hub assembly. Thus, a system that supports the hub or reduces the force applied to the hub is desired. Moreover, a system and method that is relatively simple and easy to use is desired.

### SUMMARY OF THE INVENTION

The foregoing needs are met, to a great extent by the present invention, wherein in one aspect an apparatus and method is provided that in some embodiments, a stud is installed or removed from a flat disc portion of a wheel hub. A substantial amount or all of the force used to install or remove the wheel stud is applied to an end portion of the stud other than the stud's threads.

In addition, in some embodiments of the invention, force that is applied to the flat disc portion of the hub assembly is done in such a manner and at such levels as to not significantly warp, bend, deform or otherwise permanently alter the geometry of the flat disc portion of the wheel assembly when a stud is removed or installed. Finally, in some embodiments of the present invention, the system and method for installing and removing wheel studs is a relatively simply, economical and easy to use system and method.

In accordance with one embodiment of the present invention a wheel stud installing and removing system is provided. According to some embodiments of the invention, the system includes: a C-frame; a forcing screw configured to communicate with the C-frame to move laterally through the C-frame; and a swivel mounted on an end on the forcing screw; an adapter receiver mounted on an opposite end of the C-frame from the forcing screw, and configured to receive at least one of either a stud installing adapter and a stud removing adapter.

In accordance with another embodiment of the present invention, a method of moving a stud is provided. In some embodiments of the invention the method includes inserting one of either an inserting adapter or a removing adapter into an adapter receiver on a C-frame; aligning a longitudinal axis of the adapter with a longitudinal axis of the stud; aligning a longitudinal axis of a forcing screw; and turning the forcing screw.

In accordance with yet another embodiment of the present invention, a wheel stud installing and removing system is provided. According to some embodiments of the invention, the system includes: a frame; means for forcing configured to communicate with the frame to move laterally through the frame; means for swiveling mounted on an end on the forcing means; and means for receiving an adapter mounted on an opposite end of the frame from the forcing means, and configured to receive at least one of either a stud installing adapter and stud removing adapter.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a system and method for installing a wheel stud on a hub assembly in accordance with one embodiment of the invention.

FIG. 2 is a perspective view taken from a different angle of that shown in FIG. 1 of the embodiment illustrated in FIG. 1.

FIG. 3 is a perspective view of a wheel stud installing and removing system according to an embodiment of the invention, showing a step in the process of removing a wheel stud from a hub assembly.

FIG. 4 is a perspective view of a stud removing adapter that is shown in operation in FIG. 3.

FIG. 5 is a perspective view of a wheel stud removing adapter having a slightly different geometry then the wheel stud removing adapter shown in FIG. 4.

FIG. 6 is a perspective view of a stud removing adapter that is used in some embodiments of the current invention.

FIG. 7 is a perspective view of a stud installing adapter used in some embodiments of the invention.

FIG. 8 is a perspective view of a stud installing adapter used in conjunction with the stud installing adapter of FIG. 7 in some embodiments of the invention.

FIG. 9 is a perspective view of a wheel stud installing and removing system in the process of removing a wheel stud from a hub assembly according to one embodiment of the invention.

FIG. 10 is a perspective view of a wheel stud installing and removing system in the process of removing a stud from a hub assembly using one of the adapters shown in either FIGS. 4 or 5 and the adapter shown in FIG. 6.

FIG. 11 is a perspective view of the wheel hub and wheel stud installing and removing system shown in FIG. 10 taken from a different angle than that illustrated in FIG. 10.

FIG. 12 is an exploded view of a wheel stud installing and removing system with the wheel stud removing adapters shown in either FIGS. 4 and 5, and the wheel stud removing adapter of FIG. 6.

### DETAILED DESCRIPTION

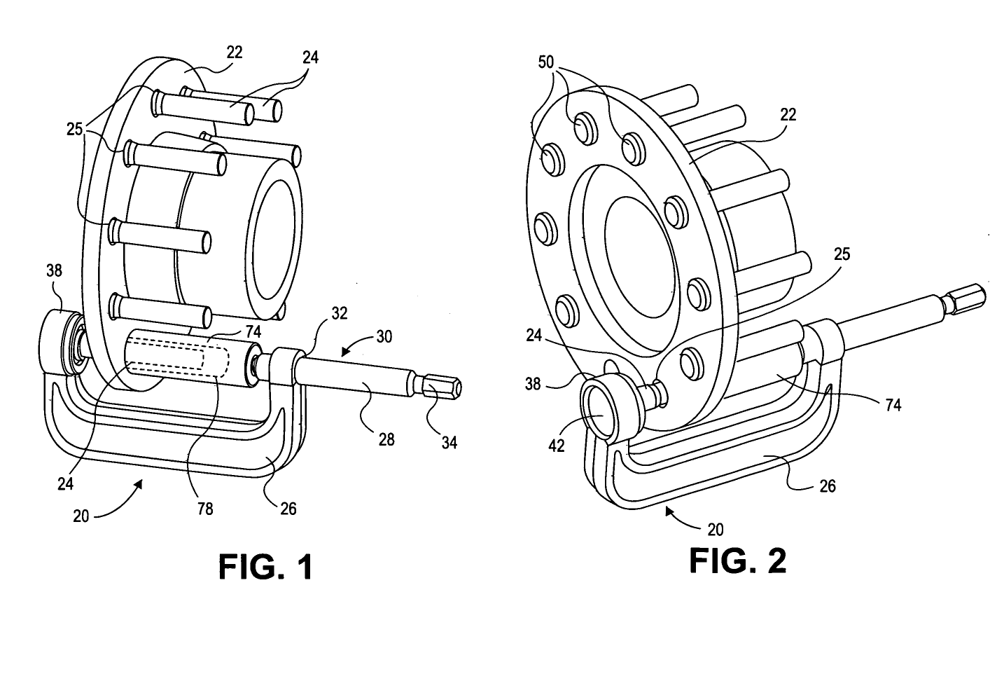

The invention will now be described with reference to the drawing figures in which like reference numerals refer to like parts throughout. An embodiment of the invention provides a system and method for installing and removing wheel studs onto and off of a wheel hub. An embodiment of the present inventive system is illustrated in FIG. 1.

FIG. 1 shows a system 20 in accordance with the invention. The system 20 is shown engaged with a wheel hub 22. In the wheel hub 22 are studs 24. The studs 24 are press fit into holes 25 in the hub 22. It is common for studs 24 when fully installed, to be press fit into the holes 25 so tightly that the studs 24 cannot be removed easily by hand. Rather, tools are often used in order to remove the studs 24. Likewise, installing studs 24 into the holes 25 of the hub 22 also is often done with tools because of the tight fit between the stud 24 and the hole 25.

In accordance with the present invention, a wheel stud installing and removing system and method will now be described. The wheel stud installing and removing system 20 includes a C-frame 26. The C-frame 26 has mounted in it a forcing screw 28. The forcing screw 28 includes external threads 30, which are located about the perimeter of the forcing screw 28. The forcing screw 28 extends through a threaded hole 32 on the C-frame 26. The threads 30 on the forcing screw 28 interact with the threaded hole 32 in order to permit the forcing screw 28 to move longitudinally through the threaded hole 32 on the C-frame 26 when the forcing screw 28 is rotated.

In some embodiments of the invention, rotating the forcing screw 28 in one direction will cause the forcing screw 28 to move away from the hub 22. Rotating the forcing screw 28 in the opposite direction will cause the forcing screw 28 to move toward the hub 22.

Some embodiments of the invention include a hex head 34 located on the forcing screw 28. The hex head 34 permits tools such as an impact wrench, socket, or any other type of wrench to assist in turning the forcing screw 28.

In other embodiments of the invention, other suitable structure may be located on the forcing screw 28 in order for the forcing screw 28 to be more easily turned by either hand or tools.

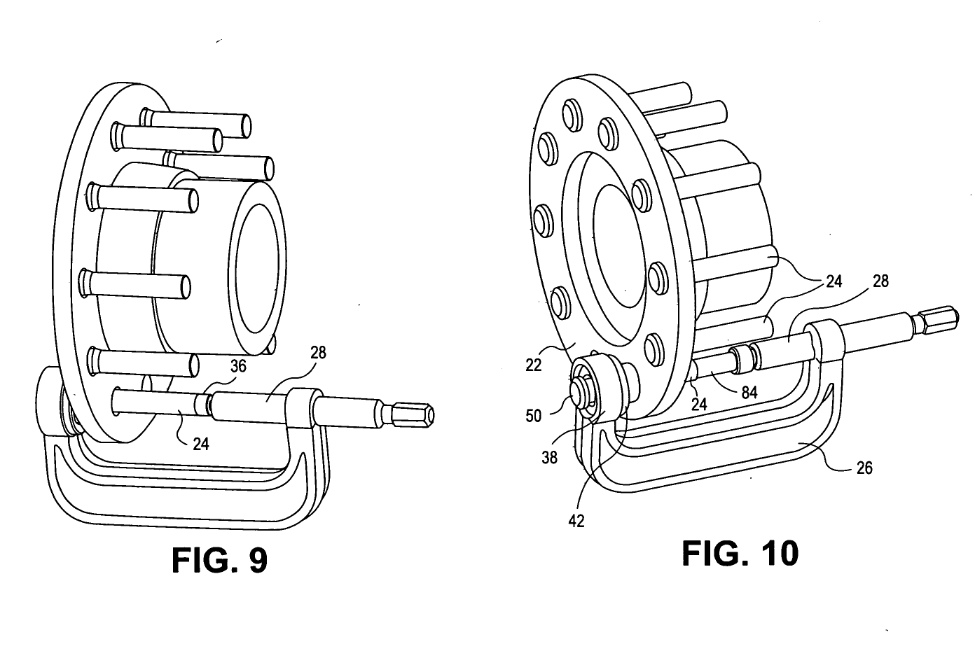

On the opposite end of the forcing screw 28 from the hex head 34 is a swivel 36 (best shown in FIGS. 9 and 12). The swivel 36 rotates freely on the end of the forcing screw 28. Thus, when the forcing screw 28 is rotated against the stud 24 as shown in FIG. 9, the forcing screw 28 does not impart a significant rotational force against the stud 24. Further, the swivel 36 will also not impart a significant rotational force against adapters when the adapters are placed on the end of the forcing screw 28 as will be described with respect to other figures below.

Turning to FIG. 1, the C-frame 26, on an end opposite to that which the forcing screw 28 is mounted, has a looped receiver 38. The looped receiver 38 is best shown in FIG. 12. As shown, at least in part in several of the figures, the looped receiver 38 is a large loop that is configured to receive and, at least in part, support adapters that will be described in more detail below.

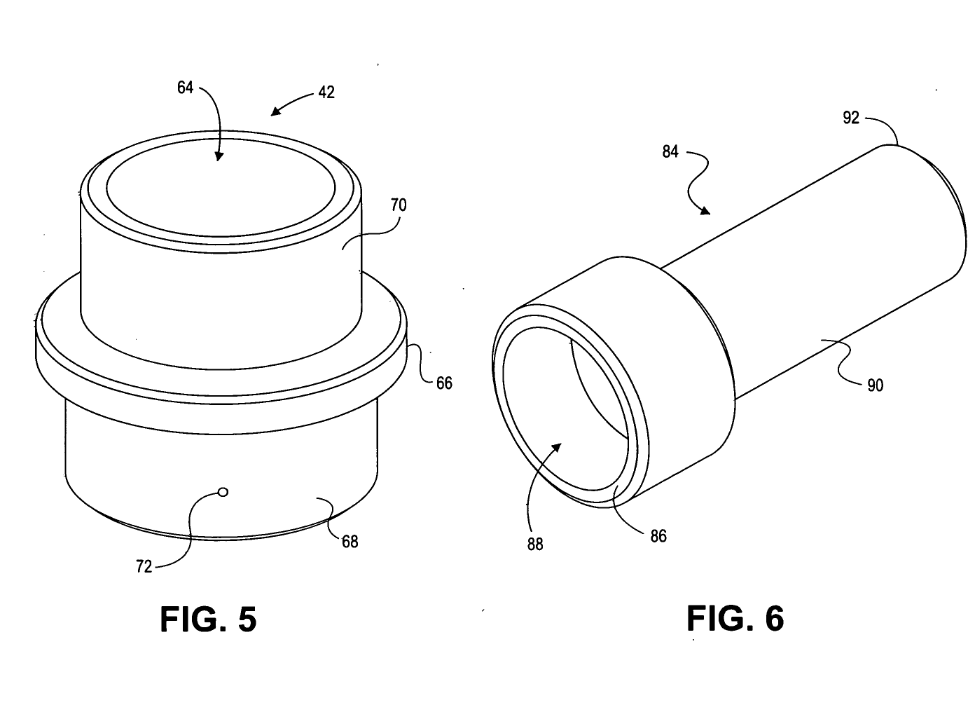

The term adapter herein generally refers to different parts of a stud installing and moving system that is installed or removed on the C-frame 26 and/or forcing screw 28 depending on how the system 20 is to be used. For example, one type of adapter that the looped receiver 38 can receive is a stud installing head 40 best shown in FIG. 8. The stud installing head 40 is used to install studs 24 into the hub 22. When it is desired to remove the studs 24 from the hub 22, the stud installing head 40 can be removed from the looped receiver 38 and replaced with a stud removing head 42 shown in FIGS. 4 and 5.

The difference between the stud removing heads 42 shown in FIGS. 4 and 5 is primarily the difference in size between the stud remover heads. The stud removing head 42 shown in FIG. 4 is for use with smaller sized studs 24 and the stud removing head 42 shown in FIG. 5 is used with larger sized studs 24 associated with large trucks and heavy pieces of equipment.

FIGS. 1 and 2 illustrate the system 20 configured to install a wheel stud 24 into a hub 22. In some embodiments of the invention, when the system 20 is configured for installing wheel studs 24, the stud installing head 40 is installed into the looped receiver 38 of the C-frame 26 as shown.

As shown in FIG. 8, the stud installing adapter 40 includes a depression 44 in the installing head 42. At the bottom of the depression 44 is a contact surface 46 surrounded by a side wall 48. In some embodiments of the invention, the diameter of the depression 44 and the depth of the side wall 48 to the contact surface 46 of the installing head 40 corresponds with the size of the head 50 (as shown in FIGS. 2, 3 and 10) of a stud 24. The size and depth of the depression 44, in some embodiments of the invention, is such that the head 50 can be secured within a depression 44 and the contact surface 46 can contact the head 50 and not have the rim 52 be contacting, or be lightly contacting the hub 22 when the stud 24 has been fully installed into the hole 25.

The stud installing head 40 includes a rim 52 and a narrow portion 54. The narrow portion 54 of the installing head 40 is dimensioned to fit within the hole 56 in the looped receiver 38 as shown in FIG. 12.

The rim 52 has a wider diameter than the narrow portion 54. Therefore the rim 52 does not enter the hole 56 of the looped receiver 38. The rim 52 is dimensioned to be large enough to withstand force applied to it from the looped receiver 38 when the system 20 is urging a stud 24 into a hub 22.

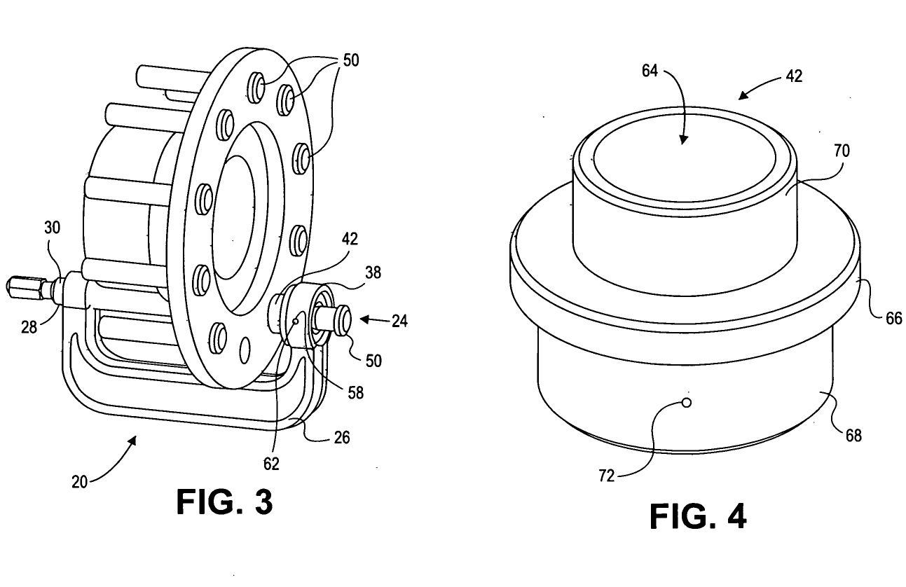

In some embodiments of the invention, the looped receiver 38 is equipped with a small cross hole 58, as shown in FIGS. 3 and 12. A thumb screw 62 is turned in the cross hole 58 and an end portion of the screw 62 holds the stud installing head 40 in the looped receiver 38 by a friction fit. In other embodiments of the invention, a corresponding cross hole 60 is found in the narrow portion 54 of the stud installing head 40, shown in FIG. 8. The cross holes 58 and 60 can be threaded and lined up so that they are aligned and a screw or pin 62 can be placed in the cross holes 58 and 60 to secure the stud removing head 22 to the C-frame 26.

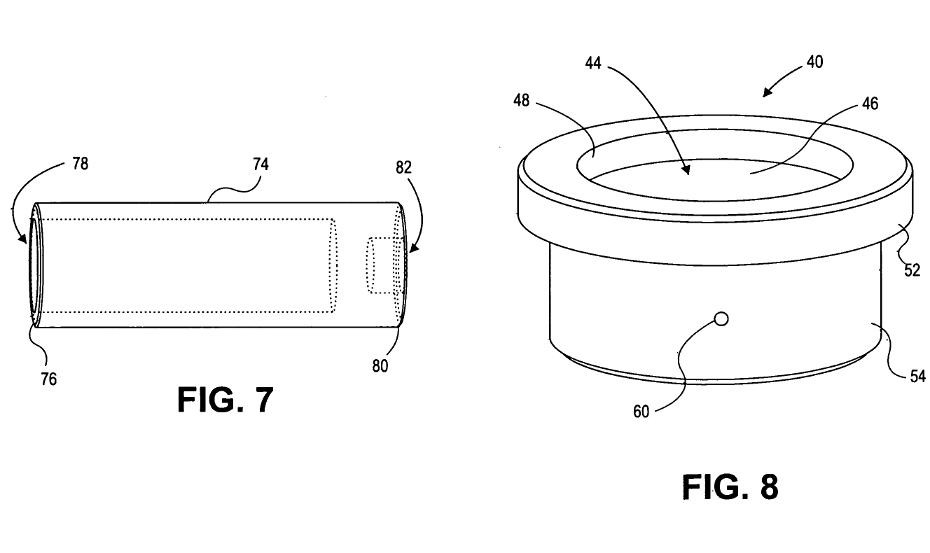

To remove the stud installing head 40 from the looped receiver 38, the screw or pin 62 affixed thereto is removed and then the stud installer head 40 can be removed from the looped receiver 38. When performing a stud 24 installing operation, an installing adapter 74, best shown in FIG. 7, but also shown in FIGS. 1 and 2, is used. As shown in FIG. 7, the installing adapter 74 has a bearing end 76. The bearing end 76 is primarily a flat surface with chamfered edges. The bearing end 76 urges against the hub 22 as shown in FIG. 1 when a stud 24 is being installed into the hole 25 on the hub 22.

The installing adapter 74 has a stud receiving hole 78 that is open to the bearing end 76 and extends through, but in some embodiments of the invention, not all the way through the installing adapter 74. Opposite the bearing end 76, on the installing adapter 74, is a swivel engaging end 80. In the swivel engaging end 80 is a swivel hole 82.

The stud installing adapter 74 is fit onto the swivel 36 of the forcing screw 28 as shown in FIGS. 1 and 2. The swivel hole 82 is dimensioned to permit the swivel 36 to fit within the swivel hole 82. The forcing screw 28 is turned until the bearing end 76 of the installing adapter 74 is fit up against the hub 22. As shown in FIGS. 1 and 2, a stud 24 extends into the stud receiving hole 76 in the installing adapter 74.

As the forcing screw 28 is turned, the hub 22 is forced toward the looped receiver 38. The stud installing head 40 provides a stop for the stud 24 so that the stud 24 is held more or less in place while the hub 22 continues to move toward the looped receiver 38. An alternative way to consider the motion is that the hub 22 remains stationary and the head 50 and looped receiver 38 move toward the hub 22. Thus, in effect, the stud 24 is installed into the hole 25 on the hub 22.

The forcing screw 28 provides force in the installing adapter 74 to the hub 22 to counter force applied to the hub 22 from the stud 24. The swivel 26 reduces or eliminates the amount of twisting force applied to the installing adapter 74.

In order to remove a stud 24 from the hub 22, the system 20 is modified so that the stud installing head 40 is removed from the looped receiver 38, and the stud removing head 42 is installed in its place. Further, the installing adapter 74 is removed from the forcing screw 28.

A system 20, in accordance with one embodiment of the invention, configured for removing a stud 24 from a hub 22 is illustrated in FIGS. 3 and 9. Turning now to FIG. 3, the stud removing and installing system 20 is shown. The C-frame 26 is placed so that the forcing screw 28 is aligned with a stud 24. The stud removing head 42 is installed into the looped receiver 38 and secured to the looped receiver 38 with a screw or pin 62. The through-hole 64 in the stud removing head 42 is aligned so that the stud 24 and the head 50 can extend through the through-hole 64 as the forcing screw 28 pushes the stud 24 through the hole 25 in the hub 22, as shown in FIG. 3.

The guide section 70 of the stud removing head 42 is placed on the hub 22 around the head 50 of the stud 24. Then the forcing screw 28 is turned, and as it turns, the external threads 30 on the forcing screw 28 interact with the threaded hole 32 in the C-frame 26 to move the forcing screw 28 longitudinally toward the looped receiver 28. The swivel 36 (best shown in FIG. 9) contacts the stud 24, and as the forcing screw 28 continues to travel, the stud 24 is pushed out of the hole 25 in the hub 22.

As shown in FIG. 10, the guide section 70 of the stud removing head 42 provides opposing force to resist the movement of the hub 22 as the stud 24 is urged forward and then through the looped receiver 38.

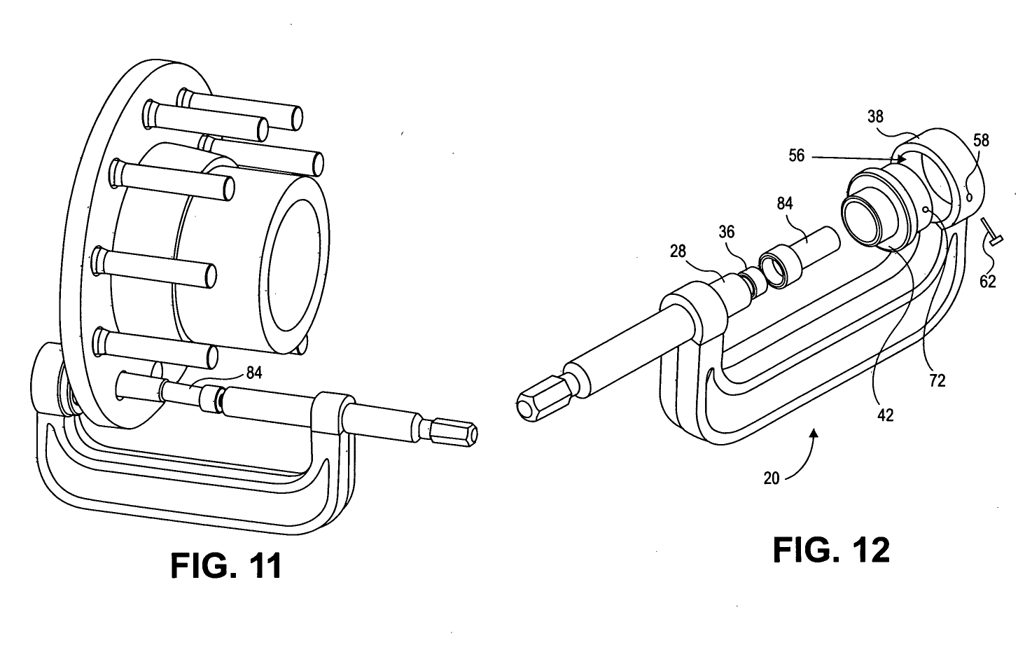

Occasionally, a stud 24 may break off or the system 20 may be used where shorter than average studs 24 are installed on a hub 22. In such instances, and in some embodiments of the invention, the system 20 can be fitted with an extension adapter 84 best shown in FIG. 6, but also illustrated in FIGS. 10-12.

Turning now to FIG. 6, the extension adapter 84 has a swivel receiving end 86. The swivel receiving end 86 includes a swivel receiving hole 88. The swivel receiving hole 88 is dimensioned so that the swivel 36 located on the end of the forcing screw 28 can fit or be seated in the swivel receiving hole 88 and secure the extension adapter 84 onto the swivel 36 thereby. The extension adapter 84 also includes a shaft 90 and a stud bearing end 92. The stud bearing end 92 urges against the end of a stud 24 when in use to remove a stud 24 as illustrated in FIG. 10.

FIG. 10 illustrates a case where the extension adapter 84 has been fitted onto the forcing screw 28. The forcing screw 28 has been turned and pushes the stud 24 out of the hub 22. The head 50 of the stud 24 is shown extending through the stud removing head 42 fit in the looped receiver 38 of the C-frame.

In some embodiments of the invention, the forcing screw 28 can completely push the stud 24 out of the hole 25 in the hub 22. In other embodiments of the invention, the forcing screw 28 is used to push the stud 24 out of the hole 25 in the hub 22 far enough so that the portion of the stud 24 nearest the head 50 has a larger diameter than the rest of the stud 24, is moved out of the hole 25. At that point, the stud 24 is no longer press fit within the hole 25 of the hub 22 and may then be removed by hand.

FIG. 12 is an exploded view of the system 20 configured for removing studs 24. The optional extension adapter 84 is shown to be aligned with the forcing screw 28. The stud removing head 42 is shown as having not yet entered the hole 56 in the looped receiver 38 and the pin or screw 62 has not yet entered the holes 58 and 72 to secure the stud removing head 42 to the looped receiver 38.

Thus, in some embodiments of the invention, the system 20 having a C-frame has different heads 40, 42 that can be installed into the looped receiver 38 depending on whether a user wants to install or remove studs 24 from a hub 22. Further, different adapters 74 and 84 are attached to the forcing screw 28 depending on whether a user intends to remove or install a stud 24 into a hub 22. In some embodiments of the invention, the installing adapter 74 is put on the forcing screw 28 when it is desired to install a stud 24 to a hub 22. No adapter can be used, in some embodiments of the invention, when it is desired to remove a stud 24 from a hub 22. But in some embodiments of the invention, extension adapter can be fitted onto the forcing screw 28 in order to facilitate the moving of the stud 24 from the hub 22.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A wheel stud installing and removing system comprising:
a C-frame;
a forcing screw configured to communicate with the C-frame to move laterally through the C-frame;
a swivel mounted on an end on the forcing screw; and
an adapter receiver mounted on an opposite end of the C-frame from the forcing screw, and configured to receive at least one of either a stud installing adapter and a stud removing adapter.

2. The system of claim 1, further comprising a hex head on the forcing screw.

3. The system of claim 1, further comprising a stud installing adapter configured to be mounted in the adapter receiver the stud installing adapter having a depression in it located and sized to receive and fit over a wheel stud head when a wheel stud is being moved through a hole in a wheel by the forcing screw.

4. The system of claim 3, further comprising a narrow diameter section of the stud installing adapter sized to fit into a adapter receiver hole and a larger diameter section sized to not fit into the adapter receiver hole.

5. The system of claim 3, further comprising a cross screw and a threaded hole in the adapter receiver wherein the cross screw is configured to enter into the hole and secure the stud installing adapter to the C-frame.

6. The system of claim 1, further comprising a stud removal adapter comprising configured to fit onto the C-frame having a hole extending through the adapter, the hole aligned with the forcing screw when the adapter is mounted on the C-frame.

7. The system of claim 6, further comprising a narrow diameter section of the stud removal adapter sized to fit into a adapter receiver hole and a larger diameter section sized to not fit into the adapter receiver hole.

8. The system of claim 6, further comprising a second stud removal adapter configured to fit onto the C-frame having a hole extending through the adapter, the hole aligned with the forcing screw when the second adapter is mounted to the C-frame, the hole in the second stud removal adapter having a diameter larger then the hole in the stud removal adapter.

9. The system of claim 6, further comprising a cross screw and a threaded hole in the adapter receiver and a cross screw can enter into the hole and secure the stud remover adapter to the C-frame.

10. The system of claim 6, further comprising a forcing adapter configured to extend a length the forcing screw can move the stud, the forcing adapter configured to attach to the forcing screw.

11. The system of claim 1, further comprising a second stud installing adapter comprising:
a long body;
a deep hole in one end of the body, the hole dimensioned to have a diameter sufficient to permit a wheel stud to fit into the hole; and
a second end of the second stud installing adapter having a second hole dimensioned to receive the swivel.

12. A method of moving a stud comprising:
inserting one of either an installing adapter or a removing adapter into an adapter receiver on a C-frame;
aligning a longitudinal axis of the adapter with a longitudinal axis of the stud;
aligning the longitudinal axis of the stud with a longitudinal axis of a forcing screw; and
turning the forcing screw.

13. The method of claim 12, further comprising:
turning the forcing screw to move toward a removing adapter in the C-frame; and
moving a head portion of the stud through a hole in the removing adapter.

14. The method of claim 13, further comprising: contacting the stud directly with swivel portion of the forcing screw.

15. The method of claim 13, further comprising: positioning a second removing adapter on the forcing screw between the swivel portion and the stud.

16. The method of claim 12, further comprising:
engaging a head of the stud in a depression in an inserting adapter;
positioning a second installing adapter on the forcing screw;
positioning an end of the second installing adapter to butt against a wheel hub the second installing adapter surrounding a hole in the wheel hub;
moving a stud through the hole in the wheel hub and in hole in the second installing adapter by turning the forcing screw.

17. The method of claim 12, wherein the forcing screw is turned via a wrench.

18. The method of claim 12, further comprising securing one of either the installing adapter or a removing adapter in place with a screw extending though a hole in the C-frame.

19. A wheel stud installing and removing system comprising:
a frame;
means for forcing configured to communicate with the frame to move laterally through the frame;
means for swiveling mounted on an end on the forcing means; and
means for receiving an adapter mounted on an opposite end of the frame from the forcing means, and configured to receive at least one of either a stud installing adapter and stud removing adapter.

20. The system of claim 19, further comprising a stud installing adapter configured to be mounted in the means for receiving an adapter, the stud installing adapter having means for securing a head of a stud when a wheel stud is being moved through a hole in a wheel by the means for forcing.

21. The system of claim 19, further comprising a stud removal adapter configured to fit onto the frame having a hole extending through the adapter, the hole aligned with the means for forcing when the adapter is mounted on the frame.

22. The system of claim 21, further comprising a forcing adapter configured to extend a length the means for forcing can move the stud, the forcing adapter configured to attach to the means for forcing.
